(19) United States
(12) Patent Application Publication
(10) Pub. No.: US 2009/0306846 A1
(43) Pub. Date: Dec. 10, 2009

(54) Diagnosis System for Cylinder Deactivation Device of Vehicle and Method for the Same

(75) Inventor: Hoon JEONG, Yongin-city (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMPANY, Seoul (KR); KIA MOTORS CORPORATION, Seoul (KR)

(21) Appl. No.: 12/333,799

(22) Filed: Dec. 12, 2008

(30) Foreign Application Priority Data
Jun. 4, 2008 (KR) 10-2008-0052786

(51) Int. Cl. G06F 7/00; G06F 15/00

(52) U.S. Cl. 701/29; 702/183

(57) ABSTRACT

A diagnosis system for a cylinder deactivation device (CDA device) may include a vehicle state detecting portion that detects operating states of a vehicle and/or an engine, a control portion that controls ON/OFF states of the CDA device according to the operating states of the vehicle and/or the engine received from the vehicle state detecting portion after determining whether the operating states satisfy a predetermined operation condition, analyzes the operating states of the vehicle and/or the engine with respect to the ON/OFF states of the CDA device, determines whether the CDA device malfunctions, and outputs diagnostic codes according to function or malfunction state of the cylinder deactivation device, and a display device that displays the function or malfunction state of the CDA device.

### CROSS-REFERENCE TO RELATED APPLICATION

The present application claims priority to Korean Patent Application Number 10-2008-0052786 filed Jun. 4, 2008, the entire contents of which application is incorporated herein for all purposes by this reference.

### BACKGROUND OF THE INVENTION

1. Field of the Invention

The present invention relates to a diagnosis system for a cylinder deactivation (CDA) device, and a method for the same.

2. Description of Related Art

Recently, enhancement of fuel consumption has been an important factor according to a rapid increase in fuel cost.

A cylinder deactivation (CDA) device deactivates some cylinders to minimize fuel consumption in an idle condition or a low load condition.

For example, in a V8 engine, two cylinders in each bank are activated and the remaining two cylinders in each bank are deactivated by operations of the CDA device for enhancement of fuel consumption in an idle condition or a low load condition.

In a V6 engine, the three cylinders of one bank are activated and the three cylinders of the other bank are deactivated by operations of the CDA device.

When the CDA device is operated, fuel is not supplied to the deactivated cylinders and friction may be minimized so that fuel consumption can be enhanced.

Referring to FIG. 1 to FIG. 3, operations of the CDA device will be explained.

The CDA device includes an inner tappet 3, which contacts a stem 1 of an intake/exhaust valve, and an outer tappet 5, which is disposed coaxially outside of the inner tappet 3. A locking pin 7 selectively connects or disconnects the inner tappet 3 from the outer tappet 5 by hydraulic pressure that is supplied from a cylinder head.

A low lift cam 11 and a high lift cam 13 are disposed to a camshaft 9, and the low lift cam 11 and the high lift cam 13 respectively contact the inner tappet 3 and the outer tappet 5.

When the CDA device is operated and the locking pin 7 disengages the inner tappet 3 from the outer tappet 5, valve lift of the intake/exhaust valve is subject to a lobe of the low lift cam 11.

Thus, the valve is not opened despite rotation of the camshaft 9 and combustion does not occur in the combustion chamber.

When the operation of the CDA device is stopped and the locking pin 7 engages the inner tappet 3 and the outer tappet 5, valve lift of the intake/exhaust valve is subject to a lobe of the high lift cam 13.

Thus, the valve is opened according to rotation of the camshaft 9 and combustion occurs in the combustion chamber.

The locking pin 7 is operated according to an operation of a hydraulic pressure control valve disposed in the cylinder head.

However, the CDA device may malfunction, such as a when valves are inappropriately maintained in a normal operation state or a deactivated operation state due to a bad operation of the hydraulic pressure control valve, the locking pin, and so on.

For example, when the CDA device is controlled to an ON state, the intake and exhaust valves may remain in an inappropriate normal operation state because of a malfunction.

In this case, misfiring and loss of output may occur and fuel may enter the combustion chamber. Also, if this malfunction continues, a catalytic converter and the engine may be damaged.

On the contrary, when the CDA device is controlled to an OFF state, the intake and exhaust valves may remain in an inappropriate deactivated operation state because of a malfunction.

In this case, output of the engine may be deteriorated and fuel may remain in an intake manifold. Also, if this malfunction continues, the catalytic converter and the engine may be damaged.

In general, a malfunction of the CDA device has been determined according to differences in air flow, which is detected by an oxygen sensor, and air flow, which is calculated using a throttle valve opening.

That is, when the CDA device is controlled to be operated, if it is determined that an air amount that is detected by an oxygen sensor is equivalent to an air amount that is normally supplied to the cylinders, it is determined that the intake and exhaust valves remain in an inappropriate normal operation state because of a malfunction.

On the contrary, when the CDA operation is controlled to be stopped, if it is determined that an air amount that is detected by an oxygen sensor is equivalent to an air amount that is present when the cylinders are deactivated, it is determined that the intake and exhaust valves remain in an inappropriate deactivated operation state because of a malfunction.

However, the conventional malfunction detecting method as described above does not output sufficient results under various driving conditions.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a diagnosis system for a cylinder deactivation (CDA) device and a method for the same, which may output reliable results under various driving conditions using various factors.

In an aspect of the present invention, a diagnosis system for a cylinder deactivation device (CDA device), may include a vehicle state detecting portion that detects operating states of a vehicle and/or an engine, a control portion that controls ON/OFF states of the CDA device according to the operating states of the vehicle and/or the engine received from the vehicle state detecting portion after determining whether the operating states satisfy a predetermined operation condition, analyzes the operating states of the vehicle and/or the engine with respect to the ON/OFF states of the CDA device, determines whether the CDA device malfunctions, and outputs diagnostic codes according to function or malfunction state of the cylinder deactivation device, and a display device that displays the function or malfunction state of the CDA device.

The vehicle state detecting portion may include a throttle valve opening detector that detects a throttle valve opening, an air pressure detector that detects air pressure supplied to a cylinder, a load detector that detects an engine load, an engine speed detector that detects engine speed, a vehicle speed detector that detects vehicle speed, an oil temperature detector that detects engine oil temperature, a voltage detector that detects battery voltage, and an oxygen sensor that detects whether an air/fuel ratio is lean or rich.

The control portion may activate the ON state of the CDA device while the operating states of the vehicle and/or the engine satisfies a predetermined operation condition

The operating states may include engine load, engine speed, vehicle speed, engine oil temperature, and/or battery voltage.

The operating states may be configured to satisfy the predetermined operation condition when the engine load is in predetermined ranges, the engine speed is in predetermined ranges, the vehicle speed is higher than a predetermined speed, the engine oil temperature is higher than a predetermined temperature, and/or the battery voltage is higher than a reference voltage.

The control portion may determine whether the CDA device malfunctions according to analyzing a change rate of air pressure, a change rate of a throttle valve opening, and/or whether an air/fuel ratio is lean or rich in the ON/OFF states of the cylinder deactivation device.

The control portion may identify presence of the malfunction state of the CDA device and an inappropriate normal valve operation state when the CDA device is in an ON state and the change rate of the air pressure is reduced.

The control portion may identify presence of the malfunction state of the CDA device and an inappropriate normal valve operation state when the CDA device is in an ON state and the change rate of the throttle valve opening is not increased.

The control portion may identify presence of the malfunction state of the CDA device and an inappropriate normal valve operation state when the CDA device is in an ON state and the air/fuel ratio is rich.

The control portion may identify presence of the malfunction state of the CDA device and an inappropriate deactivated valve operation state when the CDA device is in an OFF state and the change rate of the air pressure is increased.

The control portion may identify presence of the malfunction state of the CDA device and an inappropriate deactivated valve operation state when the CDA device is in an OFF state and the change rate of the throttle valve opening is increased.

The control portion may identify presence of the malfunction state of the CDA device and an inappropriate deactivated valve operation state when the CDA device is in an OFF state and the air/fuel ratio is lean.

In another aspect of the present invention, a diagnosis method for a cylinder deactivation device (CDA device), may include a) activating or deactivating the CDA device after determining whether first operating states of a vehicle and/or an engine satisfy a predetermined operation condition, b) determining whether the CDA device malfunctions according to second operating states of the vehicle after activating the CDA, and c) outputting diagnostic codes according to the determined results of step b) and displaying the determined results of the step b).

The first operating states may include engine load, engine speed, engine oil temperature, vehicle speed, and/or battery voltage.

The CDA device may be activated while the engine load is in predetermined ranges, the engine speed is in predetermined ranges, the vehicle speed is higher than a predetermined speed, the engine oil temperature is higher than a predetermined temperature, and/or the battery voltage is higher than a reference voltage.

The second operating states may include a change rate of air pressure, a change rate of a throttle valve opening, and/or air/fuel ratio in a cylinder.

The diagnosis method for a cylinder deactivation device may further include concluding an inappropriate normal valve operation state when the CDA device is in an ON state while the change rate of the air pressure is reduced, the change rate of the throttle valve opening is not increased, and/or the air/fuel ratio is rich, wherein the air/fuel ratio is detected by an oxygen sensor.

The diagnosis method for a cylinder deactivation device may further include concluding an inappropriate deactivated valve operation state when the CDA device is in an OFF state while the change rate of the air pressure is increased, the change rate of the throttle valve opening is increased, and/or the air/fuel ratio is lean wherein the air/fuel ratio is detected by an oxygen sensor.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view showing a tappet of an exemplary CDA engine.

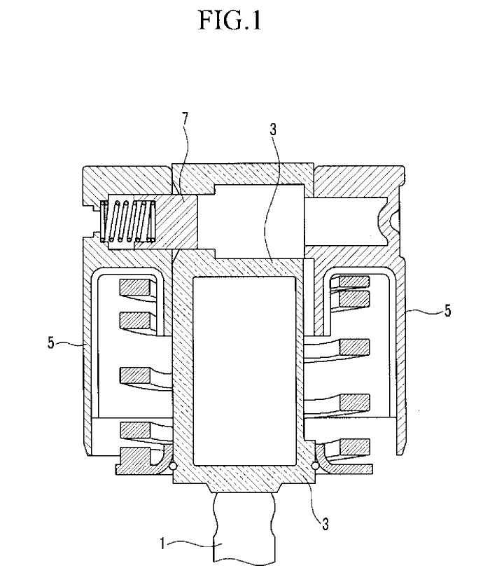

FIG. 2 is a drawing showing an OFF state of an exemplary CDA engine.

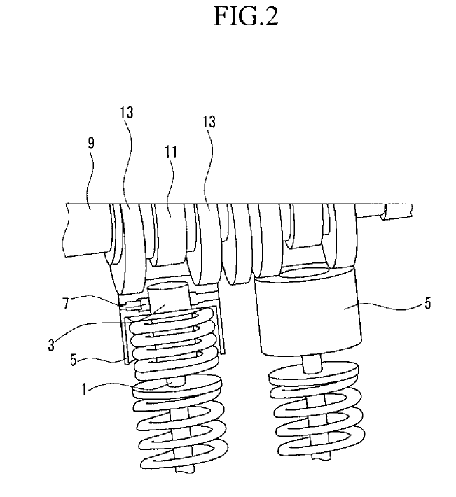

FIG. 3 is a drawing showing an ON state of an exemplary CDA engine.

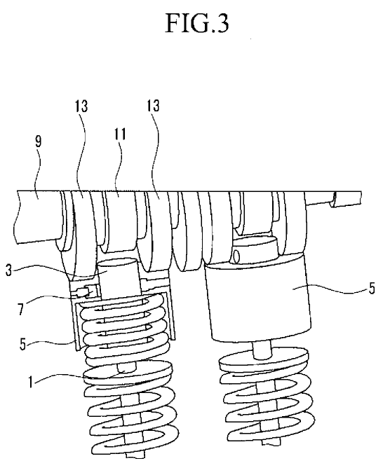

FIG. 4 is a block diagram of an exemplary diagnosis system for a CDA device according to the present invention.

FIG. 5 is a flowchart showing an exemplary diagnosis method for a CDA device according to the present invention.

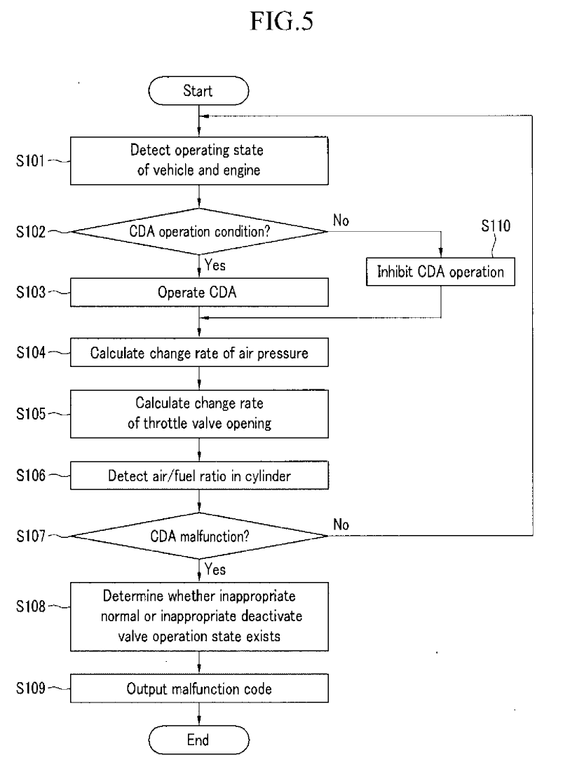

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

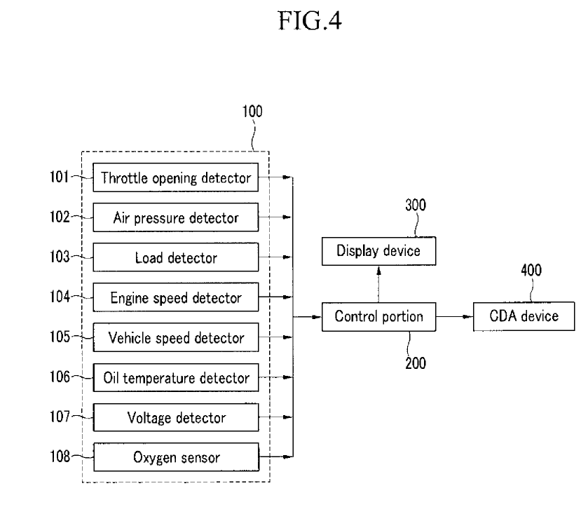

FIG. 4 is a block diagram of a diagnosis system for a CDA device according to various embodiments of the present invention.

A diagnosis system for a CDA device according to various embodiments of the present invention includes a vehicle state detecting portion 100, a control portion 200, and a display device 300.

The vehicle state detecting portion 100 detects operating states of a vehicle and an engine, and supplies results thereof to the control portion 200.

The vehicle state detecting portion 100 includes a throttle valve opening detector 101 that detects an angle of a throttle valve, an air pressure detector 102 that detects air pressure supplied to a combustion chamber, a load detector 103 that detects an engine load, an engine speed detector 104 that detects engine speed through an angle change of a crankshaft or a camshaft, a vehicle speed detector 105 that detects vehicle speed through rotation speed of an output shaft of a transmission, an oil temperature detector 106 that detects engine oil temperature, a voltage detector 107 that detects battery voltage, and an oxygen sensor 108 that detects whether an air/fuel ratio is lean or rich.

The control portion 200 determines whether the CDA device 400 is in a predetermined condition according to operating states of the vehicle and the engine, the operating states including the engine load, the engine speed, the vehicle speed, the engine oil temperature, the battery voltage, and so on.

The control portion 200 then controls a hydraulic pressure control valve of a cylinder head to be operated for controlling intake/exhaust valve lift if the operating states satisfy the predetermined condition.

After that, the control portion 200 determines whether the CDA device malfunctions, such as an inappropriate normal valve operation state or an inappropriate deactivated valve operation state, according to a change rate of air pressure, a change rate of a throttle valve opening, and whether the air/fuel ratio is lean or rich in the ON or OFF state of the CDA device 400, and outputs diagnostic codes of the determined function or malfunction of the CDA device.

The display device 300 may be disposed to an instrument cluster, and displays the determined function or malfunction state of the CDA device 400 and malfunction states of the CDA device 400 according to the diagnostic codes from the control portion 200.

Hereinafter, the diagnosis method for a CDA device according to various embodiments of the present invention will be explained.

The control portion 200 detects operation states of a vehicle that is provided with a CDA device (S101), and determines whether the CDA device 400 is in a predetermined operation condition (S102).

In the S102 step, it is determined that the CDA device 400 is in the predetermined operation condition when the engine load is in predetermined ranges, the engine speed is in predetermined ranges, the vehicle speed is higher than a predetermined speed, the engine oil temperature is higher than a predetermined temperature, and the battery voltage is higher than a reference voltage.

For example, the conditions are satisfied when the engine load is 270 KPa to 530 KPa, the engine speed is 1000 RPM to 3000 RPM, the vehicle speed is higher than 25 KPH, and the engine oil temperature is higher than 55° C.

On the contrary, in the S102 step, it is determined that the CDA device 400 is in a non-operation condition (OFF state of the CDA device 400) when one of the predetermined operation conditions for the ON state of the CDA device 400 is not satisfied.

If the predetermined operation condition of the CDA device 400 is satisfied, the control portion 200 operates a hydraulic pressure control valve in a cylinder head in order to operate the CDA device 400 (ON state of the CDA device 400) (S103). On the contrary, if the predetermined operation condition of the CDA device 400 is not satisfied, the control portion 200 operates a hydraulic pressure control valve in order to inhibit operation of the CDA device 400 (OFF state of the CDA device 400) (S110).

After controlling the CDA device 400 in the ON state, the control portion 200 analyzes a change rate of air pressure that is supplied to the combustion chamber (S104). The control portion 200 then analyzes a change rate of a throttle valve opening, which controls air flow (S105). Then the control portion 200 detects whether the air/fuel ratio is rich or lean by using the oxygen sensor 108 disposed to a cylinder bank (S106).

Thereafter, the control portion 200 determines whether the CDA device 400 malfunctions according to the change rate of air pressure, the change rate of throttle valve opening, and whether the air/fuel ratio is rich or lean (S107).

When a malfunction is not detected in the S107 step, the diagnosis of the CDA device 400 stops, and when a malfunction is detected in the S107 step, the control portion 200 determines whether an inappropriate normal valve operation state or an inappropriate deactivated valve operation state exists according to the malfunction of the CDA device 400 (S108).

For example, in a V6 engine, when the CDA device 400 is in an ON state, the three cylinders of one bank are deactivated and the three cylinders of the other bank are operated normally.

However, if the CDA device 400 malfunctions, the inappropriate normal valve operation state occurs so the valves of all six cylinders are operated.

Thus, the change rate of the air pressure is reduced when the six cylinders are operated compared to conditions when just three cylinders are operated.

When the CDA device 400 is in an ON state and three cylinders are deactivated, the throttle valve has to be opened more for generating the same torque as when the six cylinders are operated.

However, when the CDA device 400 malfunctions and the inappropriate normal valve operation state occurs, the throttle valve opening is not changed.

When the CDA device 400 is in the ON state and three combustion chambers are deactivated, an oxygen sensor signal for the deactivated bank is lowered (for example below 0.1V).

However, when the CDA device 400 malfunctions and the inappropriate normal valve operation state occurs, the oxygen sensor 108 outputs an abnormal result (for example over 0.1V).

As described above, the inappropriate normal valve operation state of the CDA device 400 can be determined.

On the contrary, in a V6 engine, when the CDA device 400 is in the OFF state, six cylinders are activated, but if the CDA device 400 malfunctions, the inappropriate deactivated valve operation state occurs so that three cylinders are deactivated.

Thus, the change rate of the air pressure is increased when the three cylinders are operated compared to conditions when the six cylinders are operated.

When the CDA device 400 is in the OFF state, but three cylinders are deactivated due to the inappropriate deactivated valve operation state, the change rate of the throttle valve opening is increased for generating the same torque as when the six cylinders are operated.

Thus, when the CDA device 400 is in the OFF state and the change of the throttle valve opening is increased, it is determined that the inappropriate deactivated valve operation state occurs.

When the CDA device 400 is in the OFF state, the oxygen sensor signal has to output a normal signal (for example over 0.1V).

However, when the CDA device 400 malfunctions and the inappropriate deactivated valve operation state occurs, the oxygen sensor 108 outputs an abnormal result (for example below 0.1V).

As described above, the inappropriate deactivated valve operation state of the CDA device 400 can be determined.

The display device 300 then outputs diagnostic codes by a predetermined method (S109).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A diagnosis system for a cylinder deactivation device (CDA device), comprising:
a vehicle state detecting portion that detects operating states of a vehicle and/or an engine;
a control portion that controls ON/OFF states of the CDA device according to the operating states of the vehicle and/or the engine received from the vehicle state detecting portion after determining whether the operating states satisfy a predetermined operation condition, analyzes the operating states of the vehicle and/or the engine with respect to the ON/OFF states of the CDA device, determines whether the CDA device malfunctions, and outputs diagnostic codes according to function or malfunction state of the cylinder deactivation device; and
a display device that displays the function or malfunction state of the CDA device.

2. The diagnosis system for a cylinder deactivation device of claim 1, wherein the vehicle state detecting portion comprises:
a throttle valve opening detector that detects a throttle valve opening;
an air pressure detector that detects air pressure supplied to a cylinder;
a load detector that detects an engine load;
an engine speed detector that detects engine speed;
a vehicle speed detector that detects vehicle speed;
an oil temperature detector that detects engine oil temperature;
a voltage detector that detects battery voltage; and
an oxygen sensor that detects whether an air/fuel ratio is lean or rich.

3. The diagnosis system for a cylinder deactivation device of claim 1, wherein the control portion activates the ON state of the CDA device while the operating states of the vehicle and/or the engine satisfies a predetermined operation condition.

4. The diagnosis system for a cylinder deactivation device of claim 3, wherein the operating states includes engine load, engine speed, vehicle speed, engine oil temperature,

5. The diagnosis system for a cylinder deactivation device of claim 4, wherein the operating states is configured to satisfy the predetermined operation condition when the engine load is in predetermined ranges, the engine speed is in predetermined ranges, the vehicle speed is higher than a predetermined speed, the engine oil temperature is higher than a predetermined temperature, and/or the battery voltage is higher than a reference voltage.

6. The diagnosis system for a cylinder deactivation device of claim 1, wherein the control portion determines whether the CDA device malfunctions according to analyzing a change rate of air pressure, a change rate of a throttle valve opening, and/or whether an air/fuel ratio is lean or rich in the ON/OFF states of the cylinder deactivation device.

7. The diagnosis system for a cylinder deactivation device of claim 6, wherein the control portion identifies presence of the malfunction state of the CDA device and an inappropriate normal valve operation state when the CDA device is in an ON state and the change rate of the air pressure is reduced.

8. The diagnosis system for a cylinder deactivation device of claim 6, wherein the control portion identifies presence of the malfunction state of the CDA device and an inappropriate normal valve operation state when the CDA device is in an ON state and the change rate of the throttle valve opening is not increased.

9. The diagnosis system for a cylinder deactivation device of claim 6, wherein the control portion identifies presence of the malfunction state of the CDA device and an inappropriate normal valve operation state when the CDA device is in an ON state and the air/fuel ratio is rich.

10. The diagnosis system for a cylinder deactivation device of claim 6, wherein the control portion identifies presence of the malfunction state of the CDA device and an inappropriate deactivated valve operation state when the CDA device is in an OFF state and the change rate of the air pressure is increased.

11. The diagnosis system for a cylinder deactivation device of claim 6, wherein the control portion identifies presence of the malfunction state of the CDA device and an inappropriate deactivated valve operation state when the CDA device is in an OFF state and the change rate of the throttle valve opening is increased.

12. The diagnosis system for a cylinder deactivation device of claim 6, wherein the control portion identifies presence of the malfunction state of the CDA device and an inappropriate deactivated valve operation state when the CDA device is in an OFF state and the air/fuel ratio is lean.

13. A diagnosis method for a cylinder deactivation device (CDA device), comprising:
a) activating or deactivating the CDA device after determining whether first operating states of a vehicle and/or an engine satisfy a predetermined operation condition;
b) determining whether the CDA device malfunctions according to second operating states of the vehicle after activating the CDA; and
c) outputting diagnostic codes according to the determined results of step b) and displaying the determined results of the step b).

14. The diagnosis method for a cylinder deactivation device of claim 13, wherein the first operating states include engine load, engine speed, engine oil temperature, vehicle speed, and/or battery voltage.

15. The diagnosis method for a cylinder deactivation device of claim 14, wherein the CDA device is activated while the engine load is in predetermined ranges, the engine speed is in predetermined ranges, the vehicle speed is higher than a predetermined speed, the engine oil temperature is higher than a predetermined temperature, and/or the battery voltage is higher than a reference voltage.

16. The diagnosis method for a cylinder deactivation device of claim 13, wherein the second operating states include a change rate of air pressure, a change rate of a throttle valve opening, and/or air/fuel ratio in a cylinder.

17. The diagnosis method for a cylinder deactivation device of claim 16, further comprising concluding an inappropriate normal valve operation state when the CDA device is in an ON state while the change rate of the air pressure is reduced, the change rate of the throttle valve opening is not increased, and/or the air/fuel ratio is rich.

18. The diagnosis method for a cylinder deactivation device of claim 16, further comprising concluding an inappropriate deactivated valve operation state when the CDA device is in an OFF state while the change rate of the air pressure is increased, the change rate of the throttle valve opening is increased, and/or the air/fuel ratio is lean.
